(19) United States
(12) Patent Application Publication
(10) Pub. No.: US 2026/0350124 A1
(43) Pub. Date: Nov. 5, 2026

(54) CLOUD COMPUTING INTERACTION SYSTEM AND METHOD

(71) Applicant: BEREEJ TECHNOLOGIES PRIVATE LIMITED, PUNE (IN)

(72) Inventors: Sudeep Mohan KHIRE, Pune (IN); Sagar Balasaheb KHATAL, Pune (IN); Shubham KHATAL, Pune (IN)

(21) Appl. No.: 19/194,261

(22) Filed: Apr. 30, 2025

(51) Int. Cl. G06F 21/31; G06F 9/451; H04L 9/40

(52) U.S. Cl. CPC G06F 21/31; G06F 9/451; H04L 63/08; G06F 2221/2117

(57) ABSTRACT

A method includes receiving a cloud computing diagram that represents a cloud computing environment, determining the cloud computing environment in a cloud computing platform by performing image processing on the cloud computing diagram, receiving user input to initiate a connection with the cloud computing environment and display a terminal associated with the cloud computing environment, receiving user credential information associated with the cloud computing environment, transmitting the user credential information associated with the cloud computing environment to a server computing device that sends the user credential information to the cloud computing environment, the server computing device connecting with the cloud computing environment, receiving terminal information that is sent from the cloud computing environment to the server computing device, and displaying the terminal associated with the cloud computing diagram that represents the cloud computing environment, the terminal being executed by the cloud computing environment and having the terminal information.

### BACKGROUND

Conventionally, cloud engineers have to use a terminal or command prompt to access virtual machines to perform activities such as installing a Software Development Kit (SDK) and changing settings. In addition, users may want to interact with a virtual machine using a graphical user interface (GUI). However, it can be difficult and cumbersome to access the virtual machine for a number of reasons.

It is with these issues in mind, among others, that various aspects of the disclosure were conceived.

### SUMMARY

According to one aspect, a cloud computing interaction system may include one or more client computing devices that may have a cloud computing interaction application and one or more server computing devices that may have the cloud computing interaction application. A user may use the client computing device to connect to a cloud computing platform account. The user may draw or open a cloud landscape diagram that represents a cloud computing architecture. The user may access a terminal or command prompt directly from the cloud landscape diagram that represents the cloud computing architecture. Alternatively, the user may access a graphical user interface such as a desktop directly from the cloud landscape diagram that represents the cloud computing architecture.

The terminal or command prompt may be displayed by a client computing device. The user may authenticate with the cloud computing architecture using one of two ways including using a username and password or using a privacy enhanced mail (PEM) file. The PEM file may have data associated with keys such as one or more private keys. In an example, a user may transmit the PEM file to a server computing device that communicates with the cloud computing architecture, create a new user account, and set a password for the cloud computing environment in response to transmitting the PEM file to the server computing device.

According to an aspect, a method includes receiving, by at least one processor, a cloud computing diagram that represents a cloud computing environment, determining, by the at least one processor, the cloud computing environment in a cloud computing platform by performing image processing on the cloud computing diagram, receiving, by the at least one processor, user input to initiate a connection with the cloud computing environment and display a terminal associated with the cloud computing environment, receiving, by the at least one processor, user credential information associated with the cloud computing environment, transmitting, by the at least one processor, the user credential information associated with the cloud computing environment to a server computing device that sends the user credential information to the cloud computing environment, the server computing device connecting with the cloud computing environment, receiving, by the at least one processor, terminal information that is sent from the cloud computing environment to the server computing device, and displaying, by the at least one processor, the terminal associated with the cloud computing diagram that represents the cloud computing environment, the terminal being executed by the cloud computing environment and having the terminal information.

According to another aspect, a system includes a computing device comprising a memory storing computer-readable instructions and at least one processor to execute the instructions to receive a cloud computing diagram that represents a cloud computing environment, determine the cloud computing environment in a cloud computing platform by performing image processing on the cloud computing diagram, receive user input to initiate a connection with the cloud computing environment and display a terminal associated with the cloud computing environment, receive user credential information associated with the cloud computing environment, transmit the user credential information associated with the cloud computing environment to a server computing device that sends the user credential information to the cloud computing environment, the server computing device connecting with the cloud computing environment, receive terminal information that is sent from the cloud computing environment to the server computing device, and display the terminal associated with the cloud computing diagram that represents the cloud computing environment, the terminal being executed by the cloud computing environment and having the terminal information.

According to an additional aspect, a non-transitory computer-readable storage medium includes instructions stored thereon that, when executed by a computing device cause the computing device to perform operations, the operations including receiving a cloud computing diagram that represents a cloud computing environment, determining the cloud computing environment in a cloud computing platform by performing image processing on the cloud computing diagram, receiving user input to initiate a connection with the cloud computing environment and display a terminal associated with the cloud computing environment, receiving user credential information associated with the cloud computing environment, transmitting the user credential information associated with the cloud computing environment to a server computing device that sends the user credential information to the cloud computing environment, the server computing device connecting with the cloud computing environment, receiving terminal information that is sent from the cloud computing environment to the server computing device, and displaying the terminal associated with the cloud computing diagram that represents the cloud computing environment, the terminal being executed by the cloud computing environment and having the terminal information.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A is a diagram of a cloud computing interaction system according to an example of the instant disclosure.

FIG. 1B is another diagram of the cloud computing interaction system according to an example of the instant disclosure.

FIG. 2A is an example method of performing password authentication setup according to an example of the instant disclosure.

FIG. 2B is an example method of displaying a remote desktop according to an example of the instant disclosure.

FIG. 3 is an example method of displaying a terminal or command prompt according to an example of the instant disclosure.

FIG. 4 is a screenshot of the graphical user interface of the cloud computing interaction application according to an example of the instant disclosure.

FIG. 5 is another screenshot of the graphical user interface of the cloud computing interaction application according to an example of the instant disclosure.

FIG. 6 is another screenshot of the graphical user interface of the cloud computing interaction application according to an example of the instant disclosure.

FIG. 7 is another screenshot of the graphical user interface of the cloud computing interaction application according to an example of the instant disclosure.

FIG. 8 is another screenshot of the graphical user interface of the cloud computing interaction application according to an example of the instant disclosure.

FIG. 9 is another screenshot of the graphical user interface of the cloud computing interaction application according to an example of the instant disclosure.

FIG. 10 is another screenshot of the graphical user interface of the cloud computing interaction application according to an example of the instant disclosure.

FIG. 11 shows an example of a system for implementing certain aspects of the present technology according to an example of the instant disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

A system and method provides cloud computing interaction and a novel approach to accessing a terminal or command prompt associated with a cloud computing environment as well as a graphical user interface interaction with a cloud computing environment. This allows users to draw or open a cloud landscape diagram that represents a cloud computing architecture. The user may access a terminal or command prompt directly from the cloud landscape diagram that represents the cloud computing architecture. Alternatively, the user may access a graphical user interface such as a desktop directly from the cloud landscape diagram that represents the cloud computing architecture.

In one example, the system provides terminal access to a cloud computing environment. Using a client computing device, the user may obtain a landscape diagram associated with a cloud computing environment that may be associated with a cloud computing platform such as a first cloud computing platform, e.g., AWS. The user may select a virtual machine such as virtual machine one, e.g., AWS EC2. A menu may be displayed for the user and the user may select a graphical user interface element such as a button associated with “Show Terminal.” The user may select the graphical user interface element associated with “Show Terminal” and a modal user interface element may be displayed. The modal user interface element may allow the user to provide a username and password or a PEM file. The user may provide a username and password to the client computing device and the client computing device may establish a connection with a server computing device such as a websocket connection. The server computing device may establish an SSH connection with a cloud computing platform computing device.

In some cases, the cloud computing platform computing device may not have username-password access. In this case, the cloud computing platform device may be accessed using a privacy enhanced mail (.pem) file. Once the user has accessed the cloud computing platform device, the user can enable the username-password access. The server computing device allows the user to enable username-password access by selecting a graphical user interface element when accessing the cloud computing platform device using the PEM file. The user may enable the username-password access and the server computing device executes a script or a set of commands. Thereafter, the user may access the cloud computing platform device using the PEM file and/or username-password.

In another example, a user may view a graphical user interface representation of the cloud computing platform device such as a Desktop.

In one example, a user may access the cloud computing platform device, e.g., a virtual machine having an operating system such as Windows, among others.

In one example, a user may use a web browser application on the client computing device to access the virtual machine and provide connection information.

The user may provide an internet protocol (IP) address associated with the cloud computing platform device as well as an associated username and password. The user may select a user interface element to “Connect” to the cloud computing platform device.

The server computing device may receive a connection request to connect with the cloud computing platform device. The server computing device may receive the request and send a request to the cloud computing platform device by sending the request to a virtual machine. In one example, the server computing device may contact an Azure VM where Docker is running. The server computing device may request that Docker create a container for this session.

As a result, a Docker container may be created. A new container starts on the Azure VM. The container is configured with the user's connection details. The container sets up a clientless remote desktop gateway to handle the RDP connection.

Next, the container connects to a Windows VM. The container establishes an RDP connection to the Windows VM. If successful, the desktop session is ready to be displayed.

The user may view a desktop of the cloud computing platform device on the client computing device. The server computing device may send a URL to the browser of the client computing device. The browser may display the Windows desktop in an iframe. As a result, the user can interact with the Windows VM directly.

The user may work with the Remote Desktop and can use mouse and keyboard to control the Windows VM. All interactions pass through the container system.

When complete, the user may end the session. When finished, user clicks “Disconnect.” The container on Azure VM is shut down and the session is ended.

This approach lets users access Windows virtual machines through a web browser without installing any special software.

Aspects of a system and method may include one or more client computing devices that may have a cloud computing interaction application and one or more server computing devices that may have the cloud computing interaction application. A user may use the client computing device to connect to a cloud computing platform account. The user may draw a cloud landscape diagram that represents a cloud computing architecture. Based on the cloud landscape diagram, the cloud computing interaction application may allow a user to interact directly from the cloud landscape diagram that represents the cloud computing architecture. Alternatively, the user may access a graphical user interface such as a desktop directly from the cloud landscape diagram that represents the cloud computing architecture.

The system includes a computing device comprising a memory storing computer-readable instructions and at least one processor to execute the instructions to receive a cloud computing diagram that represents a cloud computing environment, determine the cloud computing environment in a cloud computing platform by performing image processing on the cloud computing diagram, receive user input to initiate a connection with the cloud computing environment and display a terminal associated with the cloud computing environment, receive user credential information associated with the cloud computing environment, transmit the user credential information associated with the cloud computing environment to a server computing device that sends the user credential information to the cloud computing environment, the server computing device connecting with the cloud computing environment, receive terminal information that is sent from the cloud computing environment to the server computing device, and display the terminal associated with the cloud computing diagram that represents the cloud computing environment, the terminal being executed by the cloud computing environment and having the terminal information.

In one example, a method includes receiving, by at least one processor, a cloud computing diagram that represents a cloud computing environment, determining, by the at least one processor, the cloud computing environment in a cloud computing platform by performing image processing on the cloud computing diagram, receiving, by the at least one processor, user input to initiate a connection with the cloud computing environment and display a terminal associated with the cloud computing environment, receiving, by the at least one processor, user credential information associated with the cloud computing environment, transmitting, by the at least one processor, the user credential information associated with the cloud computing environment to a server computing device that sends the user credential information to the cloud computing environment, the server computing device connecting with the cloud computing environment, receiving, by the at least one processor, terminal information that is sent from the cloud computing environment to the server computing device, and displaying, by the at least one processor, the terminal associated with the cloud computing diagram that represents the cloud computing environment, the terminal being executed by the cloud computing environment and having the terminal information.

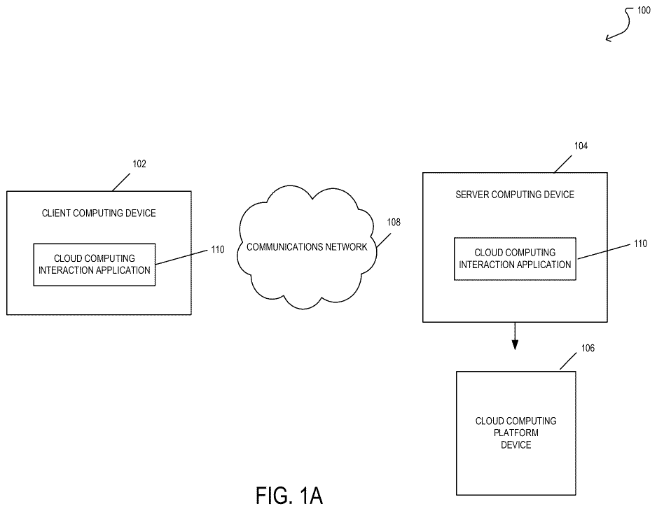

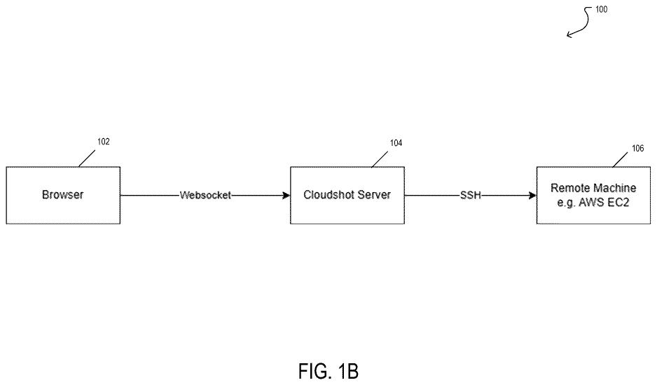

FIGS. 1A and 1B are diagrams of a cloud computing interaction system 100 according to an example of the instant disclosure. The cloud computing interaction system 100 may include at least one client computing device 102 and at least one server computing device 104 that is in communication via a communication network 108. The at least one client computing device 102 and the at least one server computing device 104 may have an application or at least one component of an application, e.g., a cloud computing interaction application 110. Each of the client computing device 102 and the server computing device 104 may have the application 110 or the at least one component of the application 110. Additionally, the cloud computing interaction system 100 may be associated with compute resources such as a cloud computing platform device 106 from one or more cloud computing platforms. The cloud computing platform device 106 may be associated with a cloud computing platform such as one or more of Amazon AWS, IBM Cloud, Google Cloud Platform, Oracle Cloud Infrastructure, Microsoft Azure, and others. In other words, the cloud computing platforms may be Cloud Platform Provider One, Cloud Platform Provider Two, Cloud Platform Three, and others.

The at least one client computing device 102 is configured to receive data from and/or transmit data to the at least one server computing device 104 through the communication network 108. Although the at least one client computing device 102 and the at least one server computing device 104 is shown as a single computing device, it is contemplated that the at least one client computing device 102 and the at least one server computing device 104 may include multiple computing devices.

The communication network 108 can be the Internet, an intranet, or another wired or wireless communication network. For example, the communication network 108 may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a Bluetooth Low Energy (BLE) network, a Bluetooth mesh network, a satellite communications network, and an IEEE 802.11 standards network, among others. Other conventional and/or later developed wired and wireless networks may also be used.

The at least one client computing device 102 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the cloud computing interaction application 110. In addition, the at least one client computing device 102 further includes at least one communications interface to transmit and receive communications, messages, and/or signals.

The server computing device 104 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or a component of the cloud computing interaction application 110. In addition, the server computing device 104 further includes at least one communications interface to transmit and receive communications, messages, and/or signals.

The at least one client computing device 102 can be a laptop computer, a smartphone, a personal digital assistant, a tablet computer, a standard personal computer, or another processing device. The at least one client computing device 102 may include a display, such as a computer monitor, for displaying data and/or graphical user interfaces. The at least one computing device 102 may also include an input device, such as one or more cameras, a keyboard or a pointing device (e.g., a mouse, trackball, pen, or touch screen) to enter data into or interact with graphical and/or other types of user interfaces. In an example, the display and the input device may be incorporated together as a touch screen of the smartphone or tablet computer.

The at least one client computing device 102 may display on the display a graphical user interface (or GUI). The graphical user interface may be provided by the cloud computing interaction application 110. The graphical user interface enables a user of the at least one client computing device 102 to interact with the cloud computing interaction application 110.

The cloud computing interaction application 110 may be a component of an application and/or service executable by the client computing device 102, the server computing device 104, and one or more cloud computing platform devices 106 or one or more cloud computing resources that may be from one or more cloud computing providers such as Cloud Computing Platform One, Cloud Computing Platform Two, Cloud Computing Platform Three, and others. For example, the cloud computing interaction application 110 may be a single unit of deployable executable code or a plurality of units of deployable executable code. According to one aspect, the cloud computing interaction application 110 may include one component that may be a web application, a native application, and/or a mobile application (e.g., an app) downloaded from a digital distribution application platform that allows users to browse and download applications developed with mobile software development kits (SDKs) including the APPLE App Store and GOOGLE PLAY®, among others.

The system 100 may also include a relational database management system (RDBMS) or another type of database management system such as a NoSQL database system that stores and communicates data from at least one database. The data stored in the at least one database may be associated with diagrams, cloud computing infrastructure, and cloud computing authentication information, among other information.

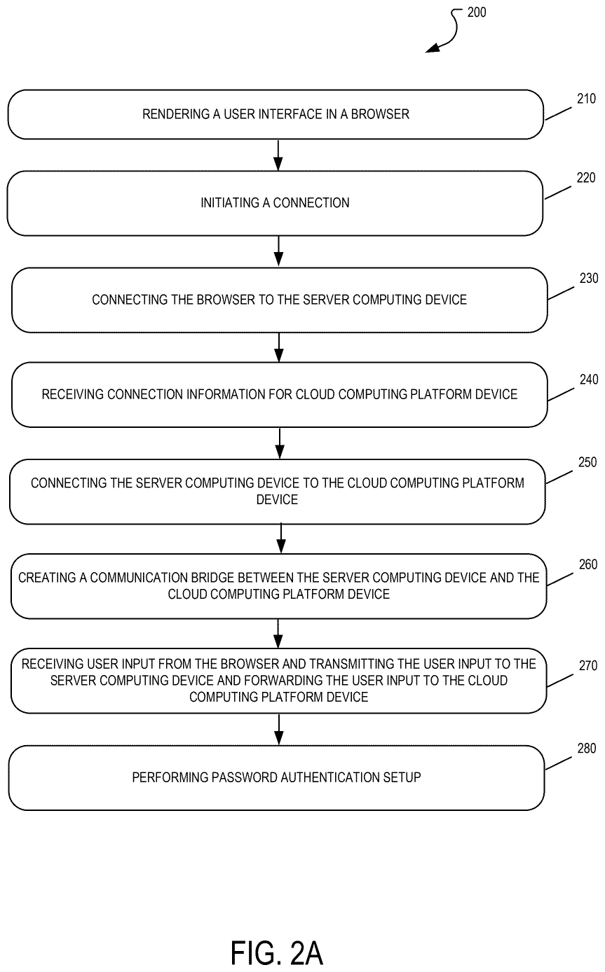

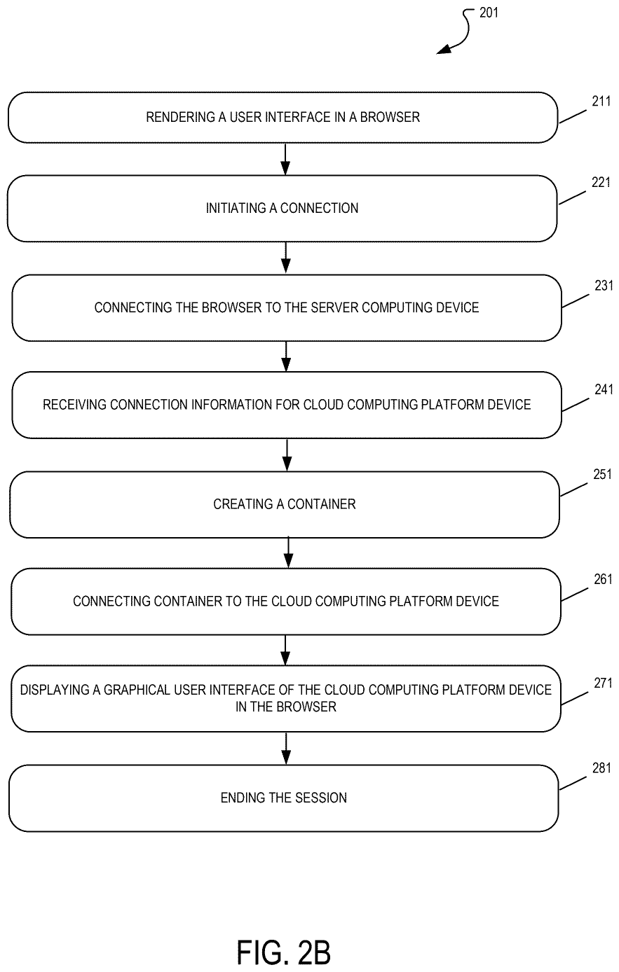

FIG. 2A is an example method 200 of performing password authentication setup according to an example of the instant disclosure. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

In block 210, a graphical user interface is loaded in a browser of the client computing device 102. In one example, the graphical user interface may have a settings sidebar and a terminal display area. If a cloud computing platform instance 106 was selected, an associated IP address and a username may be automatically filled in or populated (if the IP address and the username are available).

Next, in block 220, the user may initiate a connection. As an example, the user may provide or enter credential information such as a password or by selecting a graphical user interface element associated with a PEM key. If the PEM key is desired, the user may provide information associated with the PEM key and may select a graphical user interface element such as a “Connect” button.

Next, in block 230, the browser may connect to the server computing device 104. The browser may establish a WebSocket connection to the server computing device 104 and a connection request may be sent with authentication detail information.

Next, in block 240, the server computing device 104 may receive the connection information for the cloud computing platform device 106. The server computing device 104 may parse connection information such as host information, a username, and a password or a PEM key. The server computing device 104 may create a secure shell (SSH) client using the Node.js SSH2 library.

Next, in block 250, the server computing device 104 connects to the cloud computing platform device 106. The server computing device 104 may establish an SSH connection to the cloud computing platform device 106. If successful, a shell session is created on the cloud computing platform device 106.

Next, in block 260, a communication bridge is formed between the server computing device 104 and the cloud computing platform device 106. The server computing device 104 acts as a relay between the browser of the client computing device 102 and the cloud computing platform device 106.

Browser 102→WebSocket→Server Computing Device 104→SSH→Remote Instance 106

Remote Instance 106→SSH→Server Computing Device 104→WebSocket→Browser 102

Next, in block 270, there is user interaction through the server computing device 104. User input is received from the browser of the client computing device 102 and transmitted to the server computing device 104 and forwarded or relayed by the server computing device 104 to the cloud computing platform device 106.

Each keystroke/command from the user is sent to the server computing device 104. The server computing device forwards each keystroke/command to the SSH connection.

Any response comes back through server computing device 104 to the user's browser. For user management features, the server computing device 104 generates and executes scripts.

### Password Authentication Setup (When Not Enabled)

As in block 280, when password authentication is not enabled on the cloud computing platform device 106, the user first connects using a PEM key. After connecting, the user may select a graphical user interface element that may be a “Password Authentication & Manage User” button.

The user may provide a requested new username and select whether to grant sudo privileges. The server computing device 104 executes a script that creates the new user account, sets a password, configures sudo access if requested, modifies SSH configuration to enable password authentication, and restarts the SSH service.

After setup completes, the user can share the credentials with others. As a result, it is possible to connect to the cloud computing platform device 106 using a password instead of requiring the PEM key.

### Disconnection

When the user selects a graphical user interface element associated with “Disconnect,” the server computing device 104 closes the SSH connection. The WebSocket connection is terminated.

FIG. 2B is an example method 201 of connecting to a graphical user interface of the cloud computing platform device 106 or Desktop according to an example of the instant disclosure. Although the example method 201 depicts a particular sequence of operations, the sequence may be altered without departing from the scope of the present disclosure. For example, some of the operations depicted may be performed in parallel or in a different sequence that does not materially affect the function of the method 201. In other examples, different components of an example device or system that implements the method 201 may perform functions at substantially the same time or in a specific sequence.

In block 211, similar to 210, a graphical user interface is loaded in a browser of the client computing device 102.

Next, in block 221, similar to 220, a connection is initiated. A user may provide connection details. As an example, if a cloud computing platform device 106 is selected, an IP address and username may be automatically provided or populated (if available). If not, the user may provide an IP address associated with the cloud computing platform device 106 and select a graphical user interface element to connect.

Next, in block 231, similar to 230, the browser may connect to the server computing device 104.

In block 241, similar to 240, the server computing device 104 may receive a connection request and connection information associated with the cloud computing platform device 106 from the client computing device 102.

In block 251, the server computing device 104 may communicate with the cloud computing platform device 106 using the connection information and may create a container for a session. As an example, the server computing device 104 may contact a virtual machine where Docker is running. The server computing device 104 may request Docker to create a container for the session. The new container may start on a first virtual machine such as an Azure VM and the container may be configured with the connection details. The container may setup a clientless remote desktop gateway to handle a remote desktop protocol (RDP) connection.

Next, in block 261, the container may connect to another virtual machine, e.g., a second virtual machine. As an example, the container establishes an RDP connection to the second virtual machine, e.g., a Windows VM or a Linux VM, among others. If successful, the desktop session is ready to be displayed.

Next, in block 271, the user may view a desktop using the graphical user interface. The server computing device 104 may send information such as a URL to the browser of the client computing device 102. The browser may display the desktop in an iframe. The user can now interact with the second virtual machine, e.g., Windows VM directly. The user can use mouse and keyboard to control the second virtual machine, e.g., Windows VM. All interactions pass through the container.

In block 281, the user ends the session. When finished, the user may select a graphical user interface element such as a button to disconnect. The container on first virtual machine is shut down. The session is ended. As a result, a user may access a Windows virtual machine using the client computing device 102 through a web browser without installing any software.

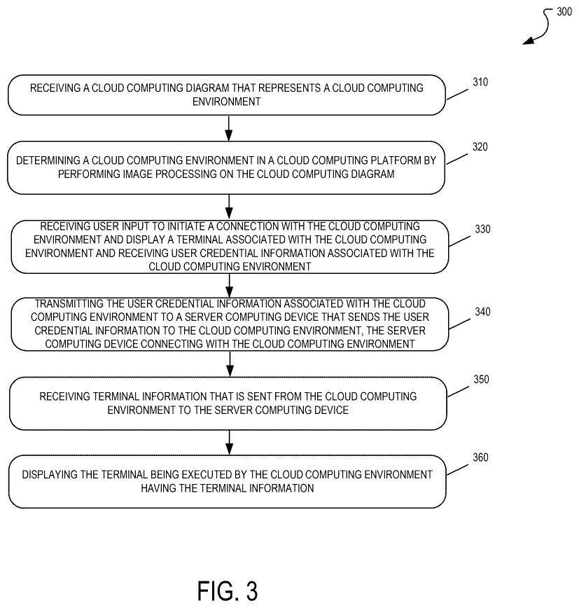

FIG. 3 shows a flowchart of a method 300 of displaying a terminal or command prompt according to an example of the instant disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 may be performed by the client computing device 102 and may include receiving, by at least one processor, a cloud computing diagram that represents a cloud computing environment that may be associated with a cloud computing platform device 106 at block 310.

According to some examples, the method 300 may include determining, by the at least one processor, the cloud computing environment in a cloud computing platform by performing image processing on the cloud computing diagram at block 320.

According to some examples, the method 300 may include receiving, by the at least one processor, user input to initiate a connection with the cloud computing environment and display a terminal associated with the cloud computing environment and may include receiving, by the at least one processor, user credential information associated with the cloud computing environment at block 330.

According to some examples, the method 300 may include transmitting, by the at least one processor, the user credential information associated with the cloud computing environment to a server computing device 104 that sends the user credential information to the cloud computing environment, the server computing device connecting with the cloud computing environment at block 340.

According to some examples, the method 300 may include receiving, by the at least one processor, terminal information that is sent from the cloud computing environment to the server computing device at block 350.

According to some examples, the method 300 may include displaying, by the at least one processor, the terminal associated with the cloud computing diagram that represents the cloud computing environment, the terminal being executed by the cloud computing environment and having the terminal information at block 360.

According to some examples, the method 300 may include transmitting a PEM file to the server computing device 104 and creating a new user account and setting a password for the cloud computing environment in response to transmitting the PEM file to the server computing device 104.

According to some examples, the method 300 may include creating a new user account and setting a password for the cloud computing environment.

According to some examples, the method 300 may include executing a script that creates a user account and sets a password for the user account for the cloud computing environment. As an example, the script may configure sudo access for the user account.

According to some examples, the method 300 may include displaying, by the client computing device 102, a tooltip as a second layer that displays on top of a first layer associated with the cloud computing diagram that represents the cloud computing environment.

According to some examples, the method 300 may include displaying a graphical user interface element that is a third layer that displays on top of the second layer and the first layer as a subset of the tooltip that when selected displays a graphical user interface element to receive the user credential information associated with the cloud computing environment.

According to some examples, the method 300 may include displaying a Show Terminal graphical user interface element or a Show Desktop graphical user interface element that is a third layer that displays on top of the second layer and the first layer as a subset of the tooltip that when selected displays a graphical user interface element to receive the user credential information associated with the cloud computing environment.

According to some examples, the method 300 may include receiving user input to a graphical user interface element that represents the terminal being executed by the cloud computing environment and transmitting the user input to the server computing device 104 using a websocket connection that transmits the user input to the cloud computing environment using an ssh connection.

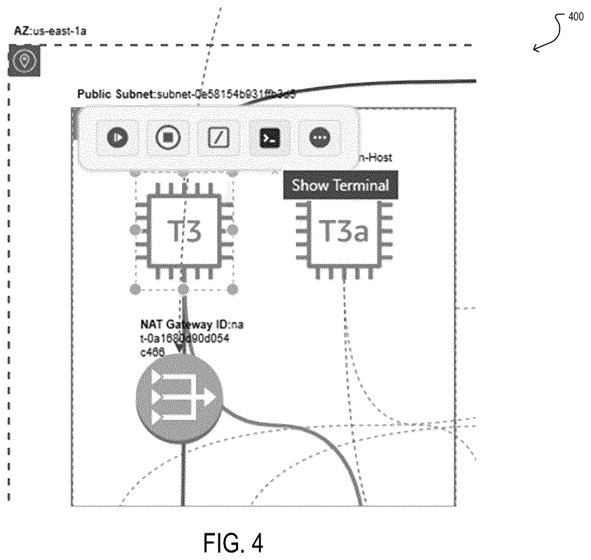

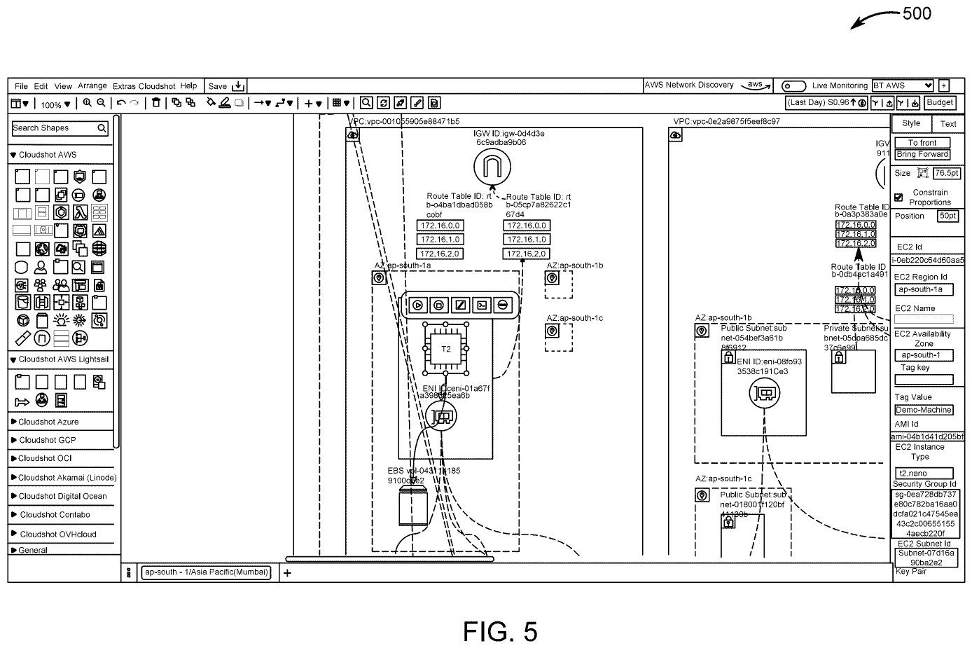

FIG. 4 is a screenshot 400 of a graphical user interface of the cloud computing interaction application 110 according to an example of the instant disclosure. FIG. 4 shows an example graphical user interface element or toolbar that shows five different options associated with the cloud computing platform device 106. One of the options is “Show Terminal” that when selected allows a user to display or show a terminal associated with the cloud computing platform device 106. FIG. 4 shows a portion of the graphical user interface that is shown in FIG. 5.

FIG. 5 is a screenshot 500 of the graphical user interface of the cloud computing interaction application 110 according to an example of the instant disclosure. As shown in FIG. 5, a graphical user interface element or toolbar may pop-up or display when a user selects a representation of a cloud computing platform device 106. FIG. 5 shows a graphical user interface that is associated with drawing a cloud computing landscape diagram.

As an example, a user may select a EC2/VM in the landscape diagram as shown in FIG. 5. One of the menu options in the toolbar is “Show Terminal.” This option is also available when a user selects or right-clicks on the EC2/VM.

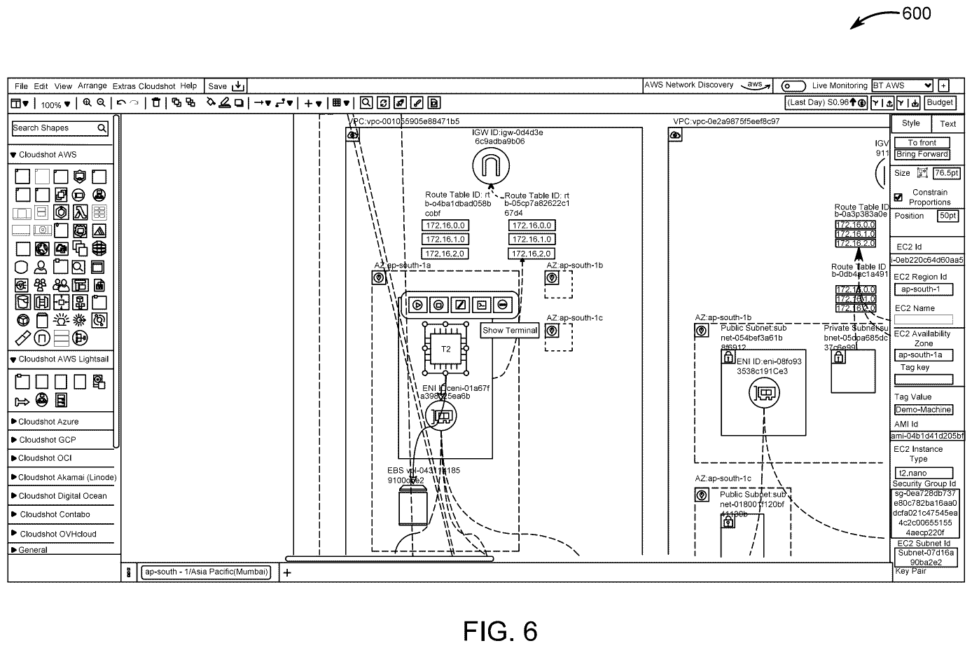

FIG. 6 is a screenshot 600 of the graphical user interface of the cloud computing interaction application 110 according to an example of the instant disclosure. As shown in FIG. 6, the toolbar shown in FIGS. 4 and 5 is displayed. However, there is a tooltip that provides more information about each option, e.g., “Show Terminal.”

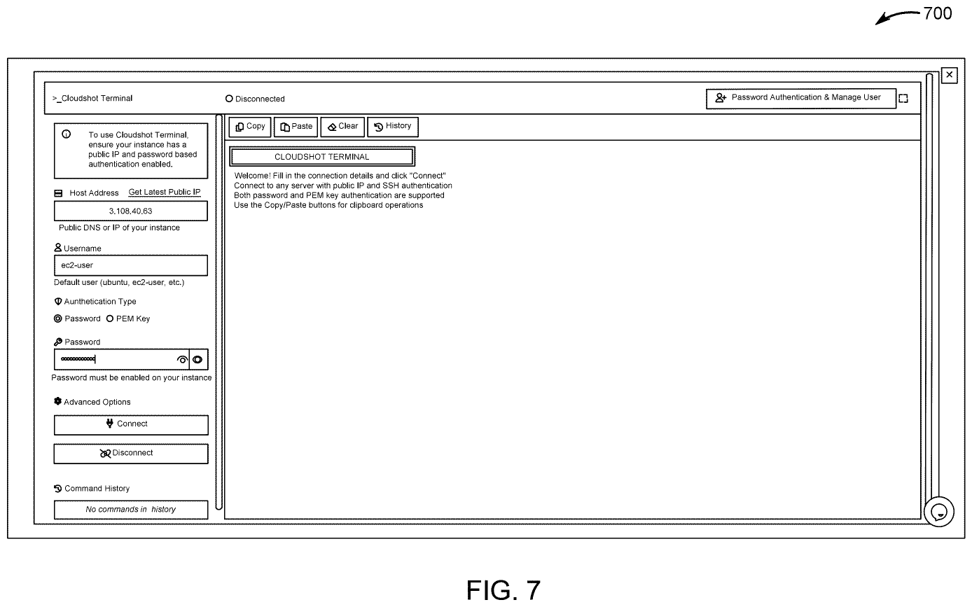

FIG. 7 is a screenshot 700 of the graphical user interface of the cloud computing interaction application 110 according to an example of the instant disclosure. As shown in FIG. 7, a modal graphical user interface is displayed. The graphical user interface includes a first graphical user interface element to provide a username and a second graphical user interface element to provide a password. When the user enters the username and password and selects a connect button or graphical user interface element, the client computing device 102 transmits a request to the server computing device 104, which forwards the request to the cloud computing platform device. The cloud computing platform device 106 may respond to the server computing device 104, which forwards the response to the client computing device 102 and a command prompt is displayed by the client computing device.

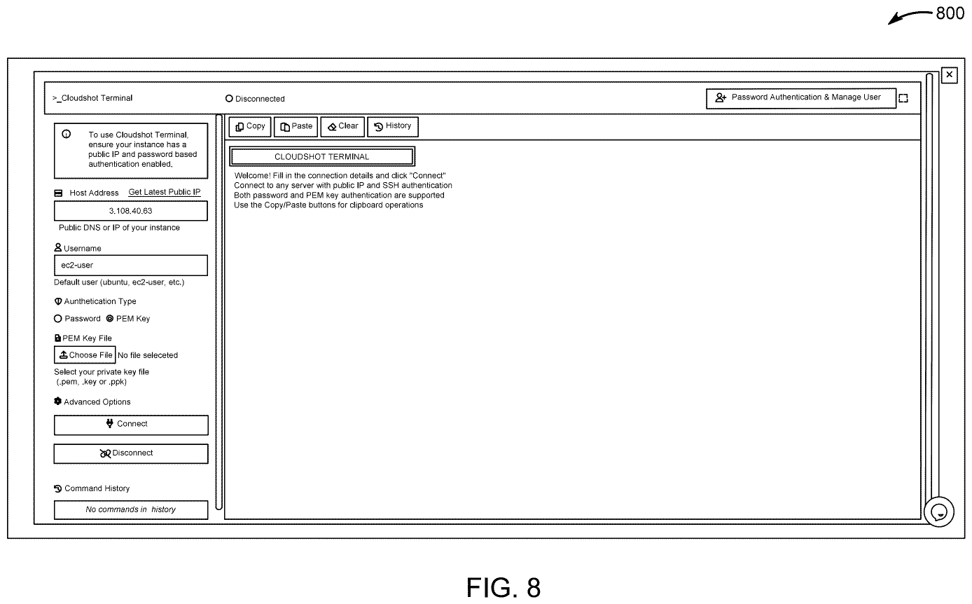

FIG. 8 is a screenshot 800 of the graphical user interface of the cloud computing interaction application 110 according to an example of the instant disclosure. As shown in FIG. 8, a user may access a cloud computing platform device 106 using a PEM file. A user may select a Choose File graphical user interface element and select a PEM file and then may select a Connect graphical user interface element. When the user enters the username and the PEM file and selects a Connect button or graphical user interface element, the client computing device 102 transmits a request to the server computing device 104, which forwards the request to the cloud computing platform device. The cloud computing platform device 106 may respond to the server computing device 104, which forwards the response to the client computing device 102 and a command prompt is displayed by the client computing device.

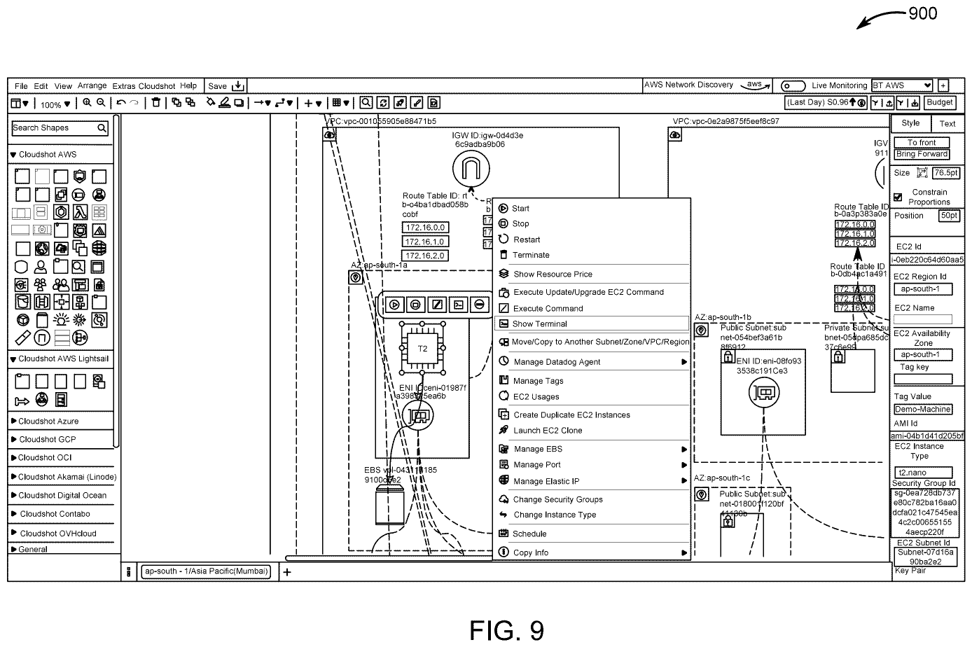

FIG. 9 is another screenshot of the graphical user interface of the cloud computing interaction application 110 according to an example of the instant disclosure. FIG. 9 shows another example graphical user interface element that may allow a user to view a terminal associated with a cloud computing platform device 106.

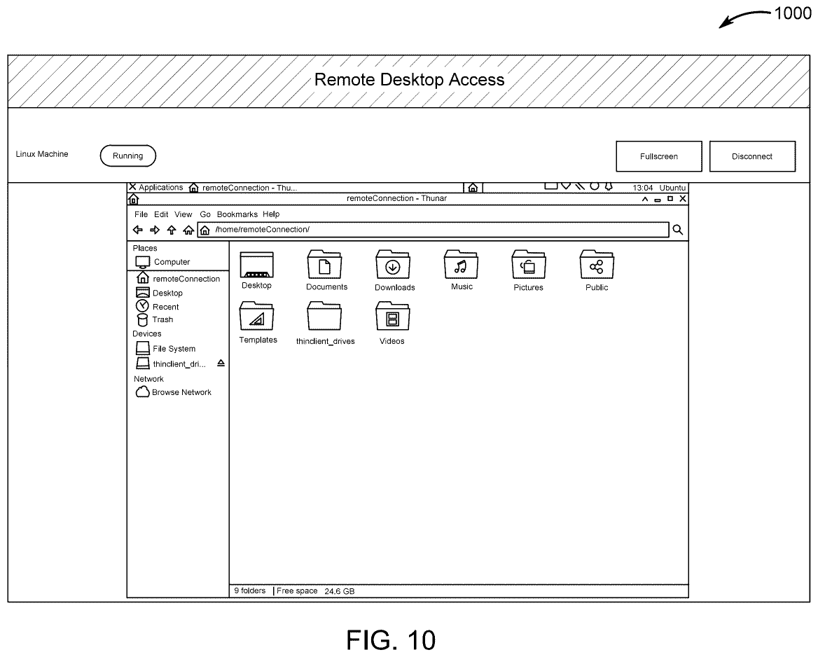

FIG. 10 is another screenshot of the graphical user interface of the cloud computing interaction application 110 according to an example of the instant disclosure. FIG. 10 shows remote desktop access of a cloud computing platform device 106 as described with respect to FIG. 2B.

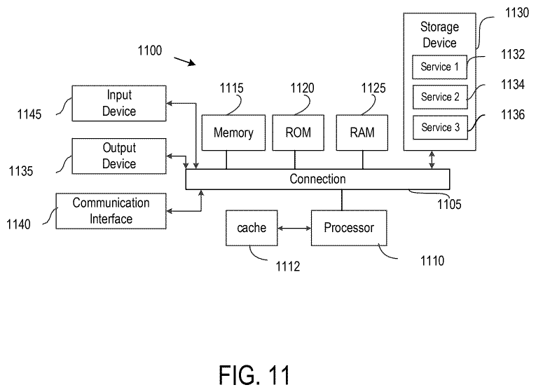

FIG. 11 shows an example of computing system 1100, which can be, for example, the client computing device 102, the server computing device 104, compute resources associated with one of the cloud computing platforms such as a cloud computing platform device 106, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache of high-speed memory 1112 connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. There is no restriction on operating on any particular hardware arrangement, and therefore the basic features here may easily be substituted for improved hardware or firmware arrangements as they are developed.

Storage device 1130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A method comprising receiving, by at least one processor, a cloud computing diagram that represents a cloud computing environment, determining, by the at least one processor, the cloud computing environment in a cloud computing platform by performing image processing on the cloud computing diagram, receiving, by the at least one processor, user input to initiate a connection with the cloud computing environment and display a terminal associated with the cloud computing environment, receiving, by the at least one processor, user credential information associated with the cloud computing environment, transmitting, by the at least one processor, the user credential information associated with the cloud computing environment to a server computing device that sends the user credential information to the cloud computing environment, the server computing device connecting with the cloud computing environment, receiving, by the at least one processor, terminal information that is sent from the cloud computing environment to the server computing device, and displaying, by the at least one processor, the terminal associated with the cloud computing diagram that represents the cloud computing environment, the terminal being executed by the cloud computing environment and having the terminal information.

Aspect 2: The method of Aspect 1, further comprising transmitting a privacy enhanced mail (PEM) file to the server computing device, and creating a new user account and setting a password for the cloud computing environment in response to transmitting the PEM file to the server computing device.

Aspect 3: The method of Aspects 1 and 2, further comprising creating a new user account and setting a password for the cloud computing environment.

Aspect 4: The method of Aspects 1 to 3, further comprising executing a script that creates a user account and sets a password for the user account for the cloud computing environment.

Aspect 5: The method of Aspects 1 to 4, wherein the script configures sudo access for the user account.

Aspect 6: The method of Aspects 1 to 5, further comprising displaying a tooltip as a second layer that displays on top of a first layer associated with the cloud computing diagram that represents the cloud computing environment.

Aspect 7: The method of Aspects 1 to 6, further comprising displaying a graphical user interface element that is a third layer that displays on top of the second layer and the first layer as a subset of the tooltip that when selected displays a graphical user interface element to receive the user credential information associated with the cloud computing environment.

Aspect 8: The method of Aspects 1 to 7, further comprising displaying a Show Terminal graphical user interface element that is a third layer that displays on top of the second layer and the first layer as a subset of the tooltip that when selected displays a graphical user interface element to receive the user credential information associated with the cloud computing environment.

Aspect 9: The method of Aspects 1 to 8, further comprising receiving user input to a graphical user interface element that represents the terminal being executed by the cloud computing environment and transmitting the user input to the server computing device using a websocket connection that transmits the user input to the cloud computing environment using an ssh connection.

Aspect 10: A system comprising a computing device comprising a memory storing computer-readable instructions and at least one processor to execute the instructions to receive a cloud computing diagram that represents a cloud computing environment, determine the cloud computing environment in a cloud computing platform by performing image processing on the cloud computing diagram, receive user input to initiate a connection with the cloud computing environment and display a terminal associated with the cloud computing environment, receive user credential information associated with the cloud computing environment, transmit the user credential information associated with the cloud computing environment to a server computing device that sends the user credential information to the cloud computing environment, the server computing device connecting with the cloud computing environment, receive terminal information that is sent from the cloud computing environment to the server computing device, and display the terminal associated with the cloud computing diagram that represents the cloud computing environment, the terminal being executed by the cloud computing environment and having the terminal information.

Aspect 11: The system of Aspect 10, the at least one processor further to execute the instructions to transmit a privacy enhanced mail (PEM) file to the server computing device and create a new user account and set a password for the cloud computing environment in response to transmitting the PEM file to the server computing device.

Aspect 12: The system of Aspects 10 and 11, the at least one processor further to execute the instructions to create a new user account and set a password for the cloud computing environment.

Aspect 13: The system of Aspects 10 to 12, the at least one processor further to execute the instructions to execute a script that creates a user account and sets a password for the user account for the cloud computing environment.

Aspect 14: The system of Aspects 10 to 13, wherein the script configures sudo access for the user account.

Aspect 15: The system of Aspects 10 to 14, the at least one processor further to execute the instructions to display a tooltip as a second layer that displays on top of a first layer associated with the cloud computing diagram that represents the cloud computing environment.

Aspect 16: The system of Aspects 10 to 15, the at least one processor further to execute the instructions to display a graphical user interface element that is a third layer that displays on top of the second layer and the first layer as a subset of the tooltip that when selected displays a graphical user interface element to receive the user credential information associated with the cloud computing environment.

Aspect 17: The system of Aspects 10 to 16, the at least one processor further to execute the instructions to display a Show Terminal graphical user interface element that is a third layer that displays on top of the second layer and the first layer as a subset of the tooltip that when selected displays a graphical user interface element to receive the user credential information associated with the cloud computing environment.

Aspect 18: The system of Aspects 10 to 17, the at least one processor further to execute the instructions to receive user input to a graphical user interface element that represents the terminal being executed by the cloud computing environment and transmit the user input to the server computing device using a websocket connection that transmits the user input to the cloud computing environment using an ssh connection.

Aspect 19: A non-transitory computer-readable storage medium comprising instructions stored thereon that, when executed by a computing device cause the computing device to perform operations, the operations comprising receiving a cloud computing diagram that represents a cloud computing environment, determining the cloud computing environment in a cloud computing platform by performing image processing on the cloud computing diagram, receiving user input to initiate a connection with the cloud computing environment and display a terminal associated with the cloud computing environment, receiving user credential information associated with the cloud computing environment, transmitting the user credential information associated with the cloud computing environment to a server computing device that sends the user credential information to the cloud computing environment, the server computing device connecting with the cloud computing environment, receiving terminal information that is sent from the cloud computing environment to the server computing device, and displaying the terminal associated with the cloud computing diagram that represents the cloud computing environment, the terminal being executed by the cloud computing environment and having the terminal information.

Aspect 20: The non-transitory computer-readable storage medium of Aspect 19, the operations further comprising transmitting a private enhanced mail (PEM) file to the server computing device and creating a new user account and setting a password for the cloud computing environment in response to transmitting the PEM file to the server computing device.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
receiving, by at least one processor, a cloud computing diagram that represents a cloud computing environment;
determining, by the at least one processor, the cloud computing environment in a cloud computing platform by performing image processing on the cloud computing diagram;
receiving, by the at least one processor, user input to initiate a connection with the cloud computing environment and display a terminal associated with the cloud computing environment;
receiving, by the at least one processor, user credential information associated with the cloud computing environment;
transmitting, by the at least one processor, the user credential information associated with the cloud computing environment to a server computing device that sends the user credential information to the cloud computing environment, the server computing device connecting with the cloud computing environment;
receiving, by the at least one processor, terminal information that is sent from the cloud computing environment to the server computing device; and
displaying, by the at least one processor, the terminal associated with the cloud computing diagram that represents the cloud computing environment, the terminal being executed by the cloud computing environment and having the terminal information.

2. The method of claim 1, further comprising:
transmitting a privacy enhanced mail (PEM) file to the server computing device; and
creating a new user account and setting a password for the cloud computing environment in response to transmitting the PEM file to the server computing device.

3. The method of claim 1, further comprising:
creating a new user account and setting a password for the cloud computing environment.

4. The method of claim 1, further comprising executing a script that creates a user account and sets a password for the user account for the cloud computing environment.

5. The method of claim 4, wherein the script configures sudo access for the user account.

6. The method of claim 1, further comprising displaying a tooltip as a second layer that displays on top of a first layer associated with the cloud computing diagram that represents the cloud computing environment.

7. The method of claim 6, further comprising displaying a graphical user interface element that is a third layer that displays on top of the second layer and the first layer as a subset of the tooltip that when selected displays a graphical user interface element to receive the user credential information associated with the cloud computing environment.

8. The method of claim 6, further comprising displaying a Show Terminal graphical user interface element that is a third layer that displays on top of the second layer and the first layer as a subset of the tooltip that when selected displays a graphical user interface element to receive the user credential information associated with the cloud computing environment.

9. The method of claim 1, further comprising receiving user input to a graphical user interface element that represents the terminal being executed by the cloud computing environment and transmitting the user input to the server computing device using a websocket connection that transmits the user input to the cloud computing environment using an ssh connection.

10. A system comprising:
a computing device comprising a memory storing computer-readable instructions; and
at least one processor to execute the instructions to:
receive a cloud computing diagram that represents a cloud computing environment;
determine the cloud computing environment in a cloud computing platform by performing image processing on the cloud computing diagram;
receive user input to initiate a connection with the cloud computing environment and display a terminal associated with the cloud computing environment;
receive user credential information associated with the cloud computing environment;
transmit the user credential information associated with the cloud computing environment to a server computing device that sends the user credential information to the cloud computing environment, the server computing device connecting with the cloud computing environment;
receive terminal information that is sent from the cloud computing environment to the server computing device; and
display the terminal associated with the cloud computing diagram that represents the cloud computing environment, the terminal being executed by the cloud computing environment and having the terminal information.

11. The system of claim 10, the at least one processor further to execute the instructions to:
transmit a privacy enhanced mail (PEM) file to the server computing device; and
create a new user account and set a password for the cloud computing environment in response to transmitting the PEM file to the server computing device.

12. The system of claim 10, the at least one processor further to execute the instructions to create a new user account and set a password for the cloud computing environment.

13. The system of claim 10, the at least one processor further to execute the instructions to execute a script that creates a user account and sets a password for the user account for the cloud computing environment.

14. The system of claim 13, wherein the script configures sudo access for the user account.

15. The system of claim 10, the at least one processor further to execute the instructions to display a tooltip as a second layer that displays on top of a first layer associated with the cloud computing diagram that represents the cloud computing environment.

16. The system of claim 15, the at least one processor further to execute the instructions to display a graphical user interface element that is a third layer that displays on top of the second layer and the first layer as a subset of the tooltip that when selected displays a graphical user interface element to receive the user credential information associated with the cloud computing environment.

17. The system of claim 15, the at least one processor further to execute the instructions to display a Show Terminal graphical user interface element that is a third layer that displays on top of the second layer and the first layer as a subset of the tooltip that when selected displays a graphical user interface element to receive the user credential information associated with the cloud computing environment.

18. The system of claim 10, the at least one processor further to execute the instructions to receive user input to a graphical user interface element that represents the terminal being executed by the cloud computing environment and transmit the user input to the server computing device using a websocket connection that transmits the user input to the cloud computing environment using an ssh connection.

19. A non-transitory computer-readable storage medium comprising instructions stored thereon that, when executed by a computing device cause the computing device to perform operations, the operations comprising:
receiving a cloud computing diagram that represents a cloud computing environment;
determining the cloud computing environment in a cloud computing platform by performing image processing on the cloud computing diagram;
receiving user input to initiate a connection with the cloud computing environment and display a terminal associated with the cloud computing environment;
receiving user credential information associated with the cloud computing environment;
transmitting the user credential information associated with the cloud computing environment to a server computing device that sends the user credential information to the cloud computing environment, the server computing device connecting with the cloud computing environment;
receiving terminal information that is sent from the cloud computing environment to the server computing device; and
displaying the terminal associated with the cloud computing diagram that represents the cloud computing environment, the terminal being executed by the cloud computing environment and having the terminal information.

20. The non-transitory computer-readable medium of claim 19, the operations further comprising:
transmitting a privacy enhanced mail (PEM) file to the server computing device; and
creating a new user account and setting a password for the cloud computing environment in response to transmitting the PEM file to the server computing device.
